(19) United States
(12) Patent Application Publication
(10) Pub. No.: US 2013/0268284 A1
(43) Pub. Date: Oct. 10, 2013

(54) System and Method for Transferring Patients Between Hospitals

(71) Applicant: Ryan Heck, Flagstaff, AZ (US)

(72) Inventor: Ryan Heck, Flagstaff, AZ (US)

(21) Appl. No.: 13/440,362

(22) Filed: Apr. 5, 2012

(51) Int. Cl. G06Q 50/22

(52) U.S. Cl. 705/2

(57) ABSTRACT

A system for transferring patients to or between hospitals comprising an online database storing information about at least two hospitals or physicians, a transfer request template, and a response template. Also provided is a physician interface for an originator, such as a physician, to populate the transfer request template to produce a completed transfer request, and to provide for selection of a selected hospital or selected physician. A hospital interface allowing a potential receiving hospital or receiving physician to view the completed transfer request and to provide a response. The server is further equipped with a communication module to transmit and receive communications between the originator and the potential receiving hospital or receiving physician. A processor executes the module which is stored on a non-transitory computer-readable storage medium.

### FIELD OF THE INVENTION

The present invention relates to a system and method for transferring patients to or between hospitals; in particular, the system includes a computer system having a database secured on a server and two or more hospitals having access to the database, preferably over the internet. The method consists generally of the steps of 1) providing an online database comprising medical facility or physician information, a transfer request template and a response template; 2) permitting access to the database to retrieve and complete a transfer request by an originator who wishes to transfer a patient, such as a physician; 3) storing the completed transfer request within the database and notifying one or more potential receiving hospitals of the completed transfer request; 4) permitting potential receiving hospitals access to the database to view the completed transfer request; 5) permitting receiving hospitals access to the database to retrieve and prepare a completed response; 6) notifying the originator of the completed response where the response is used to select one hospital for awarding the transfer; 7) receiving notification of the selection of the hospital; 8) sending a selection notification to the selected hospital notifying the hospital of its selection; and 9) sending a non-selection notification to the non-selected potential receiving hospitals notifying them of the selection.

### BACKGROUND OF THE INVENTION

Patient transfers from one hospital to another often involve the circular and time-consuming need for physicians or administrative assistants of an originating hospital (hereinafter referred to as “the Originator”) to contact one or more potential receiving hospitals (hereinafter referred to as a “PR Hospital”) to determine hospital and/or physician availability for transfer. In most cases, this contact is conducted over the telephone with the originating physician attempting to contact physicians or administrative personnel at other institutions. However, physicians are often busy and unable to answer telephone calls thereby necessitating the need for the exchange of numerous telephone messages before a discussion is even had regarding a possible transfer. Adding hospital administration into this scenario only exacerbates the situation as more parties are involved and they often have conflicting agendas. Thus, precious hours are wasted before any decision can be made regarding whether or not a physician or hospital is willing to receive a transferred patient. This problem is only compounded if, after all of this time and effort, the contacted physician or hospital is unable to accept the transfer as this requires the Originator to repeat the above procedure with a second potential transfer location.

Alternatively, an Originator can initiate telephone calls in tandem to a number of physicians/hospitals in an attempt to speed up the transfer process. However, while this approach may speed the transfer time, it also needlessly forces multiple physicians or other hospital staff to spend time responding to inquiries which lead to no transfer. Thus, the inconvenience and delay is merely reallocated and dispersed over a wider field.

With the advent of the internet, smart phones and tablets, and other web-based electronics, attempts have been made to streamline the process of patient transfers. However, many of these systems simply replace a telephone message with an electronic mail or SMS text message. Thus, it is arguable whether these approaches are any more efficient than a simple telephone call.

More advanced systems use dedicated computer software platforms to initiate and track patient transfer requests and related hospital responses. Generally, in this approach a third party system is employed which houses a database containing member physicians and/or hospitals. An Originator who is a member of the system can log onto the database and submit a transfer request. Other member physicians/hospitals can view the request and respond as to whether or not they can accept the transfer.

However, there are a number of challenges presented by the computer software-based systems currently available. One of these challenges is the lack of confirmation notifications showing receipt of the various electronic communications (e.g. the initial transfer request, whether the hospital system received the request, the hospital response, or the acceptance acknowledgement). Thus, if communication is interrupted or lost at any point in the process, one or both parties will be unaware of the loss of communication. This loss impedes or even prevents a necessary patient transfer and may have severe, if not fatal, consequences on the health of the patient.

In addition, present systems only notify the hospital which has been selected to receive the transfer. The remaining hospitals initially contacted do not receive a communication that another institution has been selected to receive the transfer. This lack of communication may lead the remaining hospitals to contact the Originator or to continue determining whether or not they can accept the transfer. Of course, this further work is moot in light of the selection but a non-notified hospital may feel obligated to pursue acceptance, particularly in view of the 1986 Emergency Medical Treatment and Active Labor Act. Thus, there is a need for a system that sends an automated notification not only to the selected hospital, but also to all other hospitals included within the initial transfer request.

Along those lines, another challenge presented with respect to prior art is a lack of unique identifying codes associated with the transfer request. Current software systems which do not provide unique identifying codes are unable to determine which physicians/hospitals have received and/or responded to a transfer request. Thus, somebody must personally review each response to determine the responding identity. This human interaction slows down the process and can potentially lead to human error. Unique identifying codes would permit software to track and register hospital responses without the need for human interaction or oversight. The unique identification codes would also aid in properly communicating with the selected and non-selected hospitals as discussed above.

Another challenge related to prior art patient transfer systems is the release of confidential patient information to physicians/hospitals which do not end up treating the patient. This release of information may subject the Originator to fines or other penalties for violating the Health Insurance Portability and Accountability Act of 1996 (HIPAA). Patient information release should be controlled so that only that information necessary for potential receiving hospitals to make a transfer decision is disclosed, without disclosing any information protected under HIPAA. Only after a hospital has been selected for transfer should specific patient information be forwarded in compliance with HIPAA to that specific hospital, without releasing that information to non-selected institutions.

Each of the above-referenced difficulties is only exacerbated by the fact that the Originator must then arrange for medical transportation of the transferee. Additional systems have been developed to aid in acquiring a transporter to complete a transfer. However, each of these systems suffers similar drawbacks as those presented above regarding transfer location selection.

As such, there is a need for a system and method that provides confirmation notifications throughout a patient transfer protocol while also notifying non-selected hospitals of a selected transfer, provides unique identifier codes to each hospital contacted, and controls release of confidential patient information. Additionally, there is a need for a system and method that provides similar confirmation notifications throughout a patient transfer protocol to assist communications between an Originator, PR Hospitals and medical transport companies to effectuate a patient transfer. The present invention addresses these and other needs.

### BRIEF SUMMARY OF THE INVENTION

In general, the present invention is directed to a system and method for transferring patients to or between hospitals that addresses the above-referenced limitations presented by prior art transfer systems, such as improved communications, confirmation notifications regarding receipt of communications, and the controlled release of confidential patient information. These features and other features of the present invention will be described in more detail below.

One aspect of the present invention is directed to a system and method for transferring patients to or between hospitals comprising an online database storing information about at least two hospitals or physicians, and a number of templates including a transfer request template and a response template. Also provided is a physician interface for an Originator to populate the transfer request template to produce a completed transfer request, and to provide for selection of a selected hospital or selected physician. A hospital interface is located at a receiving hospital or receiving physician to enable viewing of the completed transfer request and to provide a response. The server is further equipped with a communication module to transmit and receive communications between the Originator and the receiving hospital or receiving physician. A processor executes the module which is stored on a non-transitory computer-readable storage medium.

Additional objects, advantages and novel features of the present invention will be set forth in part in the description which follows, and will in part become apparent to those in the practice of the invention, when considered with the attached figures.

### BRIEF DESCRIPTION OF THE DRAWINGS

The accompanying drawings form a part of this specification and are to be read in conjunction therewith, wherein like reference numerals are employed to indicate like parts in the various views, and wherein:

FIG. 1 is a functional block diagram showing an online patient transfer system;

FIG. 2 is an exemplary screenshot showing a transfer request template;

FIG. 3 is an exemplary screenshot showing a response template;

FIG. 4 is an exemplary representation of an embodiment of a method for selecting a receiving hospital for transferring a patient between hospitals;

FIG. 5 is an exemplary representation of an embodiment of a method for selecting a transporter for transferring a patient between hospitals.

### DETAILED DESCRIPTION OF THE INVENTION

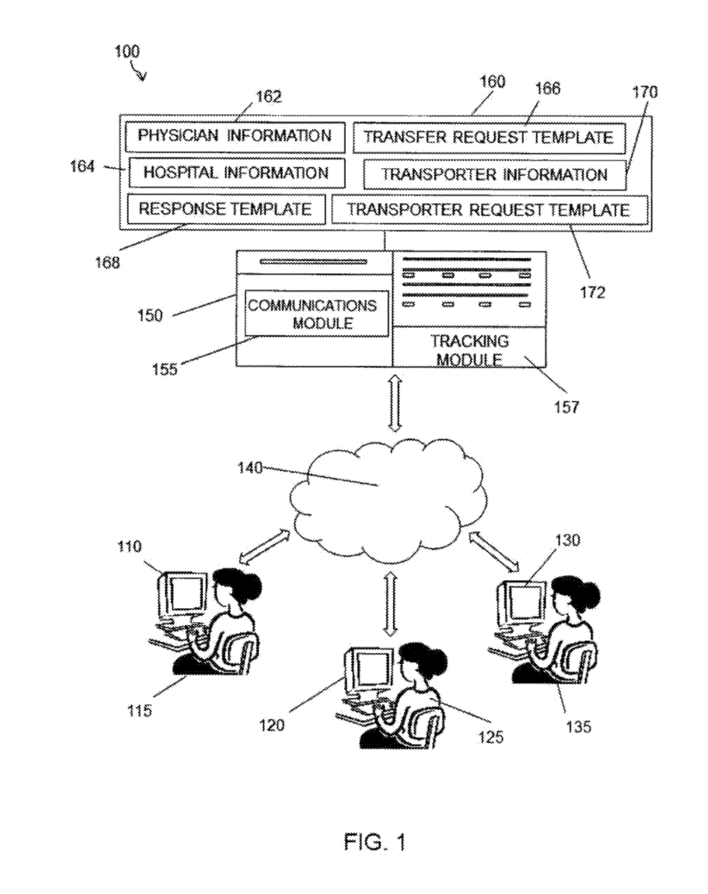

Referring to the drawings in detail, and specifically to FIG. 1, reference numeral 100 generally designates an online patient transfer system in accordance with one embodiment of the present invention. In general, the online patient transfer system 100 is comprised of database 160 housing a transfer request template 166 coupled to server 150. A transfer request template 166 and response template 168 are stored on database 160 and are accessible through one or more computers 110, 120, and 130 connected to server 150 via internet 140. Server 150 is equipped with communications module 155 for enabling communication between database 160 and each of computers 110, 120, and 130. However, while shown and described as computers, devices 110, 120, and 130 can be any web-based device such as but not limited to smart-phones, tablets, touch-screen devices and the like. In a preferred embodiment, database 160 can further include hospital information 164 and physician information 162. In a further embodiment, database 160 can also include transporter information 170 and transporter request template. Examples of hospital information include location, availability to receive new patients, number of patients being treated, physician specialties, specialized equipment, and other appropriate material. Transporter information may include number and/or type of vehicles, preferred locations, personnel specialties, and the like.

In the exemplary configuration, as shown in FIG. 1, each computer 110, 120, and 130 may, for example, be a conventional computer with a processing unit, a system memory, and a system bus that communicatively couples various system components including the system memory to the processing unit. When using the online patient transfer system 100, Originator 115, 125, or 135 accesses database 160 to retrieve a transfer request template stored within the database by way of server 150. Originator 115, 125, or 135 then utilizes an appropriate interface with computer 110, 120, or 130, respectively, to generate a completed transfer request. Examples of interfaces include keyboard, mouse, trackball, touch-screen, and the like. In a preferred embodiment, the template creates a standard transfer request having a predetermined format with at least one drop-down box, fillable field, or blank text box.

Once a transfer request has been completed, the transfer request is uploaded to server 150 and stored within database 160. In a preferred embodiment, PR hospitals or physicians are identified by the Originator during generation of the transfer request. Once the transfer request is received by server 150, a communication is directed to each of the identified PR hospitals or physicians by way of a communication module 155 housed on server 150. This communication can be any suitable electronic communication including email, instant messaging, text messaging, and display on a Website. In a preferred embodiment, each communication is allocated a unique identifying code specific to only one PR Hospital or physician for each transfer.

Once a PR Hospital or physician has received a communication that a transfer request is pending, the PR Hospital or physician can access the transfer request through the server by inputting its unique identifying code into the proper field. Importantly, once the PR Hospital or physician has received the communication, communication module 155 on server 150 sends a confirmation notification to the Originator advising of the reception. The PR Hospital or physician can then view the transfer request and provide an appropriate response by use of an appropriate interface, for example a keyboard and mouse with computer 110, 120, or 130. In a preferred embodiment, database 160 is further populated with a response template 168 to aid PR Hospitals and physicians in quickly and accurately processing and posting their availability or unavailability to receive a transfer.

Further, in a preferred embodiment, each communication initiated by the communication module 155 is time-stamped when sent so that the transmission and acknowledgement of each communication can be monitored. The time-stamped messages allow the Originator to track the response times of various potential transfer sites manually.

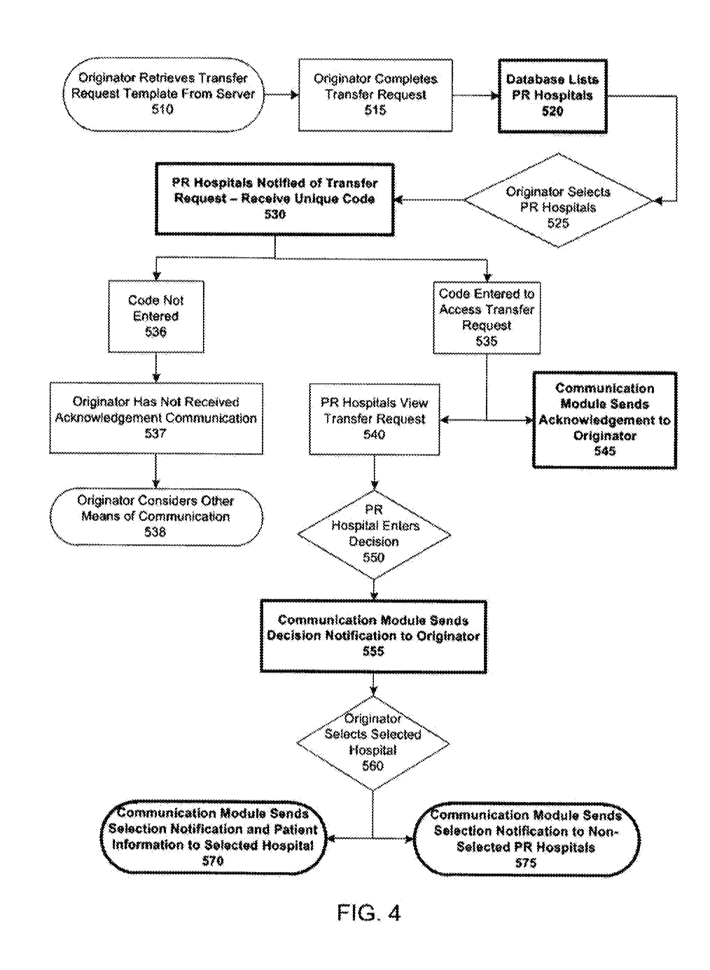

In an alternative embodiment of the invention, server 150 further houses a tracking module 157. In a preferred embodiment, tracking module 157 records communication time stamps and calculates response times from one communication to its immediately preceding communication. This type of tracking allows institutions to determine the promptness of various potential transfer locations so that Originator can use this information to aid in determining those hospitals to choose when sending transfer requests. Additionally, if a PR Hospital is known to respond promptly and the Originator has already received at least one affirmative response (as discussed below in reference to FIG. 4), the originating physician may choose to wait a short time to permit the not-yet-responded hospital a chance to submit a response. This is of particular importance if the later-responding PR Hospital is closer geographically to the patient than the affirming first-responding PR Hospital. In this scenario, although the Originator delayed in the transfer of the patient by not sending the patient to the first-responding PR Hospital, the patient may still receive quicker attention by arriving sooner at the later-responding PR Hospital. Additional tracking modalities include, but are not limited to, statistics based on source facility (originating physician), statistics based on the destination (selected hospital), and comparison of specific destination (selected hospital) versus the average statistics of all other destinations (non-selected hospitals).

Examples of transfer statistics based on source facility include: the total number of transfers, number of transfers cancelled, the number incomplete transfers, the average number and time of acknowledgement from all destinations, average number and time of response from all destinations, the average response of “no” from all destinations, the average response of “yes” from all destinations, the average number and time of acknowledgement for winning facilities, the average number and time to respond for winning facilities, the rate of acknowledgement from destination facilities and the rate of response from destination facilities.

Examples of statistics based on the destination include: providing a marker within the PR Hospital list designating that the facility is a fax-only facility, the number of transfers assigned and the average acknowledgement time and average response time, the number of transfers not assigned and the average acknowledgement time and average response time, the percent assignment of transfers received, the percent of transfers acknowledged by the facility, the percent of transfer responses designated “yes,” and the percent of transfer responses designated “no.”

Examples of comparison statistics include: the total number of transfers affecting selected destination, the average assignment rate to selected destination (count and percentage), the average response time for all transfers, the average response time by selected destination, the average acknowledgement time for all transfers, and the average acknowledgement time for selected destination.

In one embodiment of the present invention, the Originator can access database 160 to retrieve a transporter request template 172 stored within the database by way of server 150. It is envisioned that retrieval of a transporter request template can be conducted once at least one PR hospital has been identified by the Originator (as described above) or once the Originator has identified and selected a specific receiving hospital. If a transporter request template is completed after identifying at least one PR hospital but before selecting a receiving hospital, all communications between the Originator, the PR hospitals and the transporters can be carried out in parallel. After a completed transporter request is received by server 150, a communication is directed to each of the identified transporters by way of a communication module 155 housed on server 150. This communication can be any suitable electronic communication including email, instant messaging, text messaging, and display on a Website. In a preferred embodiment, each communication is allocated a unique identifying code specific to only one transporter for each transfer.

Once a transporter has received a communication that a transfer request is pending, the transporter can access the transporter request through the server by inputting its unique identifying code into the proper field. Importantly, once the transporter has received the communication, communication module 155 on server 150 sends a confirmation notification to the Originator advising of the reception. The transporter can then view the transporter request and provide an appropriate response by use of an appropriate interface, for example a keyboard and mouse with computer 110, 120, or 130. In a preferred embodiment, database 160 is further populated with a response template 168 to aid transporters in quickly and accurately processing and posting their availability or unavailability to transport a patient and the estimated times of arrival to the identified PR hospitals. While responses template 168 can be used by both PR hospitals and transporters, it is also envisioned that separate response templates can be used by each respective entity.

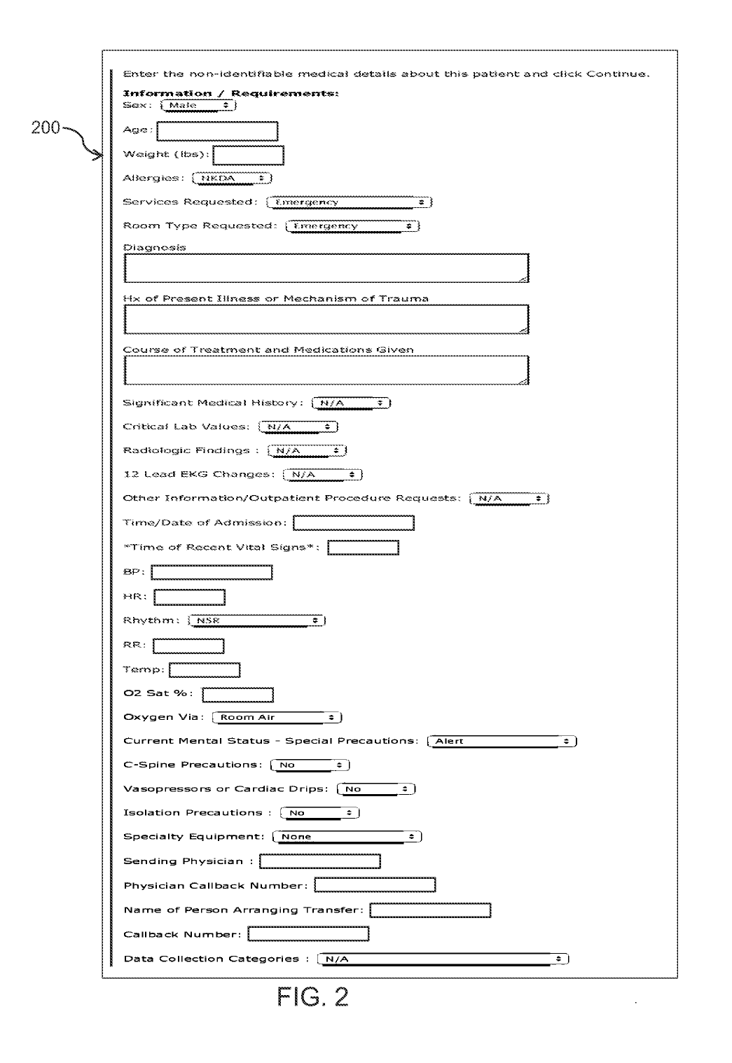

FIG. 2 presents an exemplary representation of an embodiment of a request template 200 of an online patient transfer system 100 as shown in FIG. 1. Request template 200 includes the sex, age, weight and any known allergies of a transferee. Importantly, no patient information is disclosed that would violate the provisions of HIPAA. The request template further includes information about the type of service requested, the current medical treatment of the transferee (such as a diagnosis, history of the trauma, current course of treatment, lab values, radiologic findings), the current medical status of the transferee (such as time of most recent vital sign readings, blood pressure, heart rate, temperature, oxygen saturation, and any medications), any special precautions of equipment needed, and the name and contact number for the Originator and/or the person arranging the transfer (e.g. an Originator hospital's transfer agent). Information may be inputted through a variety of options including, but not limited to text, a drop down box, a blank text box, and a fillable field.

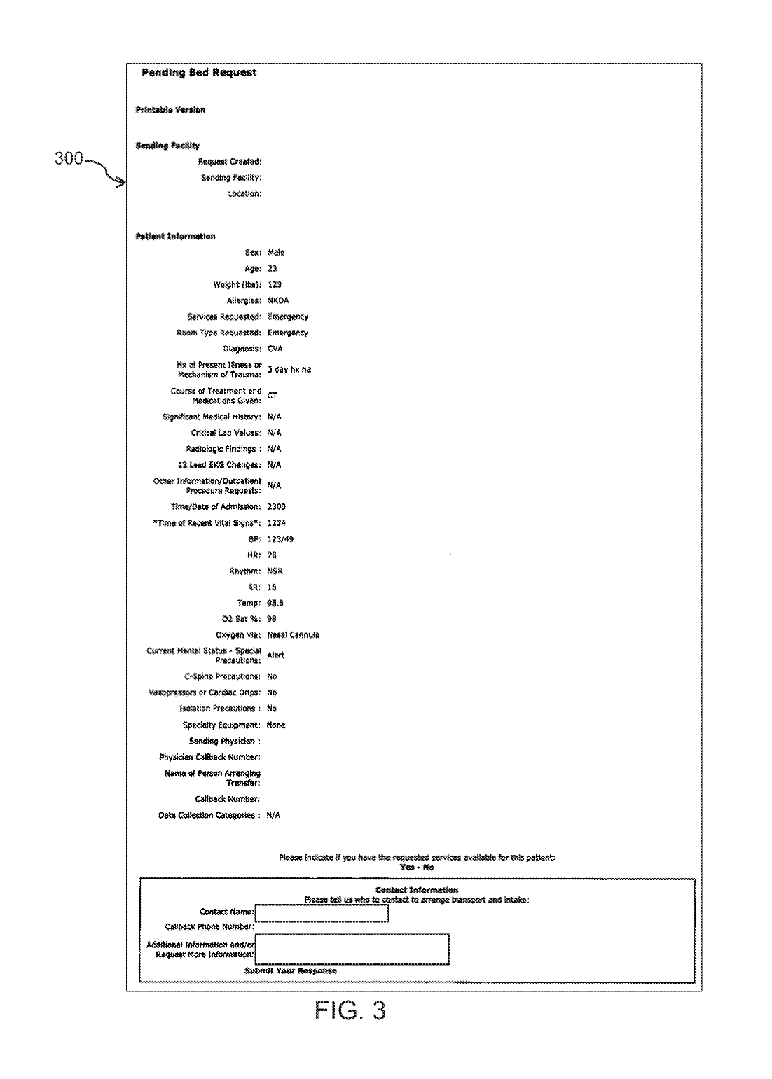

FIG. 3 is an exemplary representation of an embodiment of a response template 300 of an online patient transfer system 100 as shown in FIG. 1. Response template 300 displays the transfer request information inputted by an Originator in request template 200 in a concise, standardized manner. Thus, PR hospitals are able to quickly and easily scan a transfer request document to determine whether that facility meets the required needs and can accommodate a transfer. Following the request information, response template 300 provides a location for the PR hospital to indicate availability for transfer and the contact information of the responder to enable direct telephone contact if necessary. A PR hospital can further input additional information (such as limits on availability or whether they possess any additional specialization which may be needed in the future treatment of the transferee) and can further request additional information if needed. Information may be inputted through a variety of options including, but not limited to text, a drop down box, a blank text box, and a fillable field.

FIG. 4 presents an exemplary representation of a method for transferring patients between Originator and hospitals. It should be noted that although described as transferring patients between hospitals, the present invention envisions transfers between any medical institutions including individual or groups of physicians, hospitals, clinics, medical offices, home health care facilities, retirement homes, nursing homes, assisted living, psychiatric facilities, tertiary care facilities, rehabilitation facilities and the like. The term hospital is used herein to simplify the discussion and is meant to incorporate any of these bodies and is not meant to be limiting in any way. Referring to FIG. 4, exemplary method shown as process 500 is initiated with process step 510 where an Originator accesses the database to retrieve a transfer request template form (as described above with reference to FIGS. 1 and 2). Once accessed, the originating physician completes the template as appropriate (process step 515). In a preferred embodiment, information inputted into the template does not include any confidential patient information. Rather, only non-confidential information necessary for potential receiving hospitals to make an informed decision as to whether they have the ability to accept the transfer is provided. Examples of such information include the nature of the injuries, severity of the injuries, any special precautions that need to be implemented, any specialized materials, equipment or training required, and the like.

Once process step 515 is completed and a transfer request is ready for transmittal, the server (as described In reference to FIG. 1) retrieves a listing of hospitals satisfying the requisite criteria inputted by the Originator in the transfer request (process step 520). PR Hospitals can be listed by any desired metric, such as maximum availability, whether they accept patient insurance, or, in a preferred embodiment, by distance from the originating physician. Distance is of utmost importance because the sooner a patient is seen in an accident situation, the sooner the treatment of that patient's injuries and generally, the better the long-term prognosis. As shown in process step 525, after the server compiles the list of PR Hospitals, the Originator selects at least one, and preferably more than one, PR Hospital to inquire as to whether that hospital can accept the patient.

Once PR Hospitals are selected from the list of PR Hospitals by the Originator, the communication module of the server (see FIG. 1) sends a communication to each of the PR Hospitals selected in process step 525, notifying each of the selected PR Hospitals of a transfer request (process step 530). In a preferred embodiment, the communication module designates a unique communication code for each selected PR Hospital for each transfer request. A PR Hospital then accesses the transfer request by clicking on a hyperlink embedded within the communication, or alternatively by inputting its unique identifying code into a webpage hosted on the server. Either access method directs the PR Hospital to the system server as described above. As shown by process step 536, a potential receiving hospital has not entered its unique identifying code. The Originator can see that the communication server transmitted the transfer request but the PR Hospital has not accessed the request (process step 537). Importantly, the unique identifier code allows the Originator to know which of the PR Hospitals have not viewed the transfer request. This failure to view the request may be due to the PR Hospital's internet network being disabled, the internet communication manager is not set to receive incoming requests, or that the PR Hospital's personnel are busy or otherwise unavailable to access the transfer request. No matter the case for a PR Hospital's failure to view the request, the Originator can then consider other means of communicating with the PR Hospital (process step 538). Other means of communication could include a direct telephone call to a PR Hospital's referral department, a direct telephone call to a physician at the hospital, an email or text message, or a fax message.

Alternatively, a PR Hospital selected as a possible location for transfer enters the code (or accesses the server via hyperlink) as shown in process step 535. Once a PR Hospital's unique identification code has been entered (or the server accessed via hyperlink) (process step 535) to view the transfer request (process step 540), a notification communication is forwarded by the communication module to the Originator advising the physician of the hospital's access (process step 545). Importantly, the PR Hospital's unique identification code allows the Originator to monitor which hospitals have inputted the code and accessed the system server. Once the unique identification code has been entered by the PR Hospital (process step 535), PR Hospital personnel can then view the transfer request form (process step 540) and determine whether or not the PR Hospital has the capacity, experience, or ability to receive the transferred patient. In a preferred embodiment, a response template is presented to the PR Hospital upon its viewing of the transfer request. As shown in process step 550, after a decision has been made by the PR Hospital, the PR Hospital accesses the response template and completes the form to indicate whether or not it will accept the transfer. The PR Hospital indication is communicated to the Originator by a communication from the communication module of the system server (process step 555).

Once at least one PR Hospital has responded that it will accept transfer, the Originator selects the selected hospital (process step 560). The communication module of the server notifies each of the PR Hospitals which have heretofore accessed the server and viewed the transfer request (process steps 535 and 540). As shown in process step 570, the selected hospital is informed that it will be receiving the transfer. The decision regarding where to transfer is independent of the present invention and should involve the collaboration of the caregivers and patient. In a preferred embodiment, it is only at this time that confidential patient information is forwarded to the selected hospital in conformance with HIPAA regulations. Additionally, in a preferred embodiment, all information regarding the transfer request will be available to the Originator and the selected hospital for a defined period of time, preferably for twenty-four hours following notification of selection.

As shown in step 575, those PR Hospitals which entered their code but were not selected for the transfer receive a notification that another hospital has been selected. This notification allows non-selected PR Hospitals to terminate needless deliberations, thereby improving hospital efficiency and patient care. In a preferred embodiment, all unique identifying codes for non-selected PR Hospitals are disabled following selection of a hospital for transfer. The cancelation of the codes prevents non-selected PR Hospitals from accessing confidential patient information for a patient that is not in the care of the hospital. Additionally, all other unique codes for that transfer (except the code for the selected hospital), i.e. those PR Hospitals who have heretofore not accessed the server, are disabled. Thus, if a late-coming PR Hospital attempts to view the transfer request, that PR Hospital will be notified that its code is no longer viable.

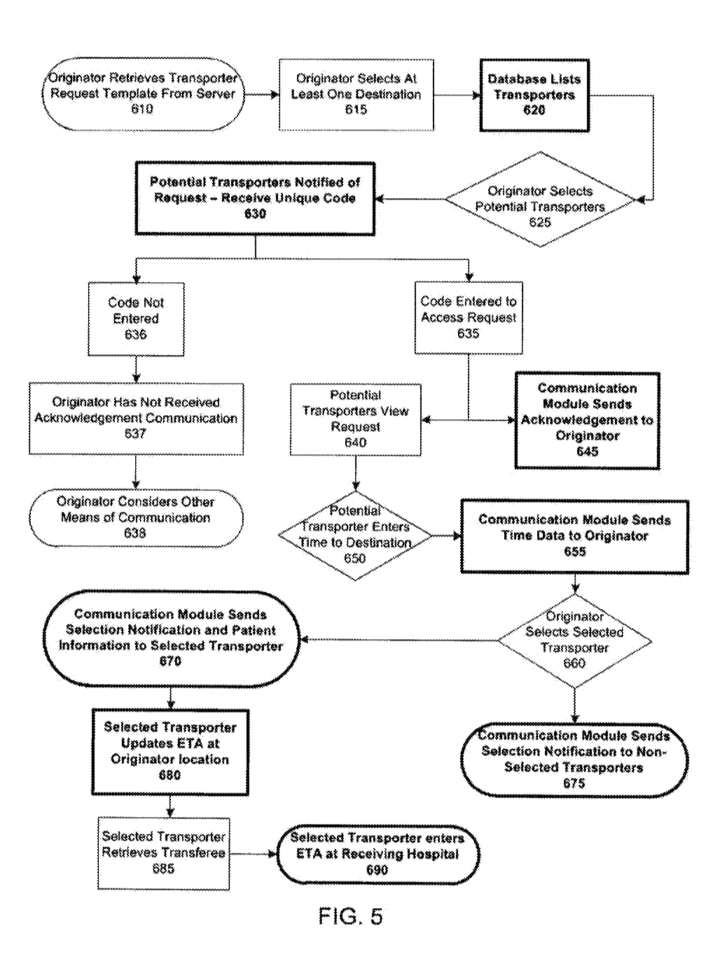

Referring to FIG. 5, exemplary method of transporting a transferee is shown as process 600 is initiated with process step 610 where an Originator accesses the database to retrieve a transporter request template form (as described above with reference to FIG. 1). Once accessed, the originating physician selects at least destination location for the transferee as appropriate (process step 615) at which point database 160 will generate a list of potential transporters (process step 620). In one embodiment of the present invention, an Originator may preselect at least one preferred transporter and store such selection on server 150. Each time a transport location is selected by an Originator, the preferred transporter(s) will be displayed at the top of the list produced in process step 620 with non-preferred transporters listed randomly thereafter. As shown in process step 625, after the server compiles the list of potential transporters, the Originator selects at least one, and preferably more than one, potential transporter to inquire as to whether that transporter can transfer the patient, and what the estimated time of transfer would be if selected. Once potential transporters are selected from the list by the Originator, the communication module of the server (see FIG. 1) sends a communication to each of the potential transporters selected in process step 625, notifying each of the selected potential transporters of a transporter request (process step 630). In a preferred embodiment, the communication module designates a unique communication code for each selected potential transporter for each transport request. A potential transporter then accesses the transport request by clicking on a hyperlink embedded within the communication, or alternatively by inputting its unique identifying code into a webpage hosted on the server. Either access method directs the potential transporter to the system server as described above.

As shown by process step 636, a potential transporter has not entered its unique identifying code. The Originator can see that the communication server transmitted the transport request but the potential transporter has not accessed the request (process step 637). Importantly, the unique identifier code allows the Originator to know which of the potential transporters have not viewed the transport request. This failure to view the request may be due to the potential transporter's internet network being disabled, the internet communication manager is not set to receive incoming requests, or that the potential transporter's personnel are busy or otherwise unavailable to access the transport request. No matter the case for a potential transporter's failure to view the request, the Originator can then consider other means of communicating with the potential transporter (process step 638). Other means of communication could include a direct telephone call to a potential transporter, an email or text message, or a fax message.

Alternatively, a selected potential transporter enters the code (or accesses the server via hyperlink) as shown in process step 635. Once a potential transporter's unique identification code has been entered (or the server accessed via hyperlink) (process step 635) to view the transport request (process step 640), a notification communication is forwarded by the communication module to the Originator advising the physician of the transporter's access (process step 645). Importantly, the potential transporter's unique identification code allows the Originator to monitor which transporters have inputted the code and accessed the system server. Once the unique identification code has been entered by the potential transporter (process step 635), transporter personnel can then view the transport request form (process step 640) and determine whether or not the transporter has the ability to transfer the patient. In a preferred embodiment, a response template is presented to the potential transporter upon its viewing of the transport request. As shown in process step 650, after a decision has been made by the transporter, the potential transporter accesses the response template and completes the form to indicate whether or not it will transfer the patient and what the estimated time to destination will be once accepted by the Originator. The potential transporter indication and time to destination data is communicated to the Originator by a communication from the communication module of the system server (process step 655).

Once at least one potential transporter has responded that it will transfer the patient, the Originator selects the selected transporter (process step 660). The communication module of the server notifies each of the potential transporters which have heretofore accessed the server and viewed the transport request (process steps 635 and 640). As shown in step 675, those potential transporters which entered their code but were not selected for the transport receive a notification that another transporter has been selected. In a preferred embodiment, all unique identifying codes for non-selected transporters are disabled following selection of a transporter. Additionally, all other unique codes for that transport (except the code for the selected transporter), i.e. those potential transporters who have heretofore not accessed the server, are disabled. Thus, if a late-coming potential transporter attempts to view the transport request, that potential transporter will be notified that its code is no longer viable. As shown in process step 670, the selected transporter is informed that it will be transporting the patient. The selected transporter then provides the Originator with an estimated time of arrival at Originator's location (process step 680). Once the selected transporter has retrieved the transferee from the Originator location (process step 685), the selected transporter notifies the receiving hospital of an estimated time of arrival to complete the transport (process step 690).

In one embodiment of the present invention, process 600 (assigning transportation of a transferee) immediately follows completion of process 500 (selection of a receiving hospital). In the serial selection embodiment, selection of a transporter only commences once a destination hospital has been chosen by the Originator. Potential transporters can then specify a time-to-destination originating at the Originator location with delivery to the selected receiving hospital (process step 650). The serial nature of selection of a hospital then transporter simplifies matters as a single variable is addressed at one time. A serial approach works best when there are a large number of PR hospitals and/or transporters as the complexity is minimized and the Originator can first focus on selecting the most appropriate receiving hospital before directing attention to selection of a transporter.

In an alternative embodiment of the present invention, process 600 is conducted in parallel with process 500. That is, once PR hospitals are selected in process step 525, an Originator can then select potential transporters to transport the transferee to any or all of the delineated PR hospitals (process step 625). A parallel approach can create a high degree of complexity as each potential transporter may provide estimated times-to-destination to each of the PR hospitals. For instance, if five PR hospitals are specified, and five potential transporters submit destination times to each of those PR hospitals, there will be twenty five potential scenarios with only one ultimately selected. Under the prior art, this is even more daunting as all of this data must be deciphered by a human being. This present invention simplifies this task as each PR hospital and each potential transporter is assigned unique codes and each communication designates that code. Thus, the database compiles and presents transporter data for each PR hospital to the Originator without requiring human interaction to correlate the data. Although the database simplifies correlations, a parallel approach may not be appropriate for transfers designating a large number of PR hospitals or potential transporters simply due to the large number of possible scenarios which are presented to the Originator. An Originator still has to review the data to make an appropriate selection of both the selected receiving hospital and the selected transporter. As a result, a parallel approach works well with a minimally complex selection involving a small number of PR hospitals and/or potential transporters. Alternatively, database 150 filters potential transporters based upon the estimated time of arrival at each of the PR hospitals as reported by the transporters in the transport response. The Originator then has the option of selecting both the hospital and transporter which correlates to the fastest time.

The present invention provides a number of advantages that overcome the problems and deficiencies that exist with prior art patient transfer systems. For example, one advantage provided by the present invention is that the communication module generates a unique identification code for every PR Hospital for each transfer request (see process step 530 in FIG. 4). This permits the Originator to monitor each PR Hospital independently to determine if and when each hospital has responded. Additionally, both the Originator and PR Hospitals can keep better track of their records as the unique identifying code is specific to a specific transfer request. This will aid in preventing transfer mistakes and confusion. Further, the unique code permits the present system to disable access of the non-selected PR Hospitals to the transfer request and confidential patient information after the Originator has selected a hospital. Thus, patient information is only released to proper parties in compliance with HIPAA regulations.

Another advantage of the present invention is that the communication module sends confirmation notifications to the appropriate party during the course of the transfer request. For instance, a confirmation notification is sent to the Originator once a PR Hospital enters its unique identifier code into the system server (process step 545 in FIG. 4). Thus, the Originator is notified if and when the transfer request has been acknowledged by the PR Hospital. The Originator can then wait for a response to the transfer request. If, on the other hand, a PR Hospital does not enter its unique code (after an arbitrary or predetermined length of time), the Originator can then attempt to contact the PR Hospital by other means (i.e. by telephone, email, or fax). An additional notification absent in the prior art is the notification to those PR Hospitals NOT selected to receive the transfer. Presently, non-selected PR Hospitals are not notified of a transfer selection and devote personnel and time to a meaningless endeavor. By receiving notification that a transfer has been accepted (to a different hospital—process step 575 in FIG. 4), the non-selected PR Hospital can immediately cease activities relating to that transfer request and can then devote those energies where appropriate. This saves time and energy while decreasing administrative costs and improving patient care.

Although the present invention has been described in considerable detail with reference to certain aspects thereof, other versions are possible. Therefore, the spirit and scope of the appended claims should not be limited to the description of the aspects contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

1. A system for transferring patients, comprising:
an online database storing a transfer request template and a response template;
an originator interface enabling a patient originator to populate said transfer request template to produce a completed transfer request, and to enable selection of a selected patient receiver selected from one or more patient receivers;
a receiver interface enabling said one or more patient receivers to view said completed transfer request and to complete said response template;
a communication module to transmit and receive communications between said patient originator and said one or more patient receivers; and
a processor to execute the module which is stored on a non-transitory computer-readable storage medium,
wherein said communication module transmits a receiver access confirmation notification to said patient originator notifying said patient originator when each of said patient receivers has accessed said completed transfer request.

2. A system according to claim 1, wherein said transfer request template further selects and ranks said one or more patient receivers by distance from said patient originator.

3. A system according to claim 1, wherein said communication module designates a unique communication code for each one or more patient receivers for each transfer request.

4. (canceled)

5. A system according to claim 1, wherein said communication module communicates at least one further communication selected from the list consisting of:
a) a completed response notification to said patient originator when each of said patient receivers has completed its response,
b) a selection communication from said patient originator to a selected patient receiver, and
c) a non-selection communication to each responding patient receiver not selected by said patient originator.

6. (canceled)

7. A system according to claim 1, wherein each of said communications is time-stamped when transmitted or received by said communication module.

8. A system according to claim 7, further comprising a tracking module and a tracking processor wherein said tracking module records said time-stamp of said communication.

9. (canceled)

10. A system of claim 8 wherein said tracking module determines a time interval between said communication and an immediately preceding communication.

11. (canceled)

12. A system according to claim 1, wherein said online database further stores a transport request template to be populated by said patient originator through said originator interface to produce a completed transport request, wherein said originator interface enables selection of a selected patient transporter selected from one or more patient transporters, and wherein said system further comprises a transporter interface enabling said one or more patient transporters to view said completed transport request and to complete said response template.

13. A system for transferring patients, comprising:
an online database storing a transport request template and a response template;
an originator interface enabling a patient originator to populate said transport request template to produce a completed transport request, and to enable selection of a selected transporter selected from one or more patient transporters;
a transporter interface enabling said one or more patient transporters to view said completed transport request and to complete said response template;
a communication module to transmit and receive communications between said patient originator and said one or more patient transporters; and
a processor to execute the module which is stored on a non-transitory computer-readable storage medium,
wherein said communication module transmits a transporter access confirmation notification to said patient originator notifying said patient originator when each of said patient transporters has accessed said completed transport request.

14. A system according to claim 13, wherein said communication module designates a unique communication code for each patient transporter for each transport request.

15. (canceled)

16. A system according to claim 13, wherein said communication module communicates at least one further communication selected from the list consisting of:
a) a completed response notification to said patient originator notifying said patient originator that one of said patient transporters has completed said response,
b) a selection communication from said patient originator to a selected patient transporter, and
c) a non-selection communication to each responding patient transporter not selected by said patient originator.

17. (canceled)

18. A system according to claim 13, wherein each of said communications is time-stamped when transmitted or received by said communication module.

19. A system according to claim 18, further comprising a tracking module and a tracking processor wherein said tracking module records said time-stamp of said communication.

20. (canceled)

21. A system of claim 19 wherein said tracking module determines a time interval between said communication and an immediately preceding communication.

22. (canceled)

23. A method to transfer a patient, comprising:
providing an online database comprising medical facility or physician information, a transfer request template and a response template;
permitting a patient originator access to said database to retrieve said transfer request template and prepare a completed transfer request;
storing said completed transfer request within said database;
providing one or more patient receivers notification of said completed transfer request;
permitting said one or more patient receivers access to said database to view said completed transfer request;
providing said patient originator notification when each of said one or more patient receivers accesses said completed transfer request;
permitting said one or more patient receivers to retrieve said response template and prepare a completed response to said completed transfer request;
providing said patient originator notification of said completed response, wherein the patient originator selects one of said one or more patient receivers to become a selected receiver for awarding said transfer and selecting all remaining said one or more patient receivers to become non-selected receivers;
sending a selection notification to said selected receiver notifying said selected receiver of said selection; and
sending a non-selection notification to said non-selected hospitals receivers notifying said non-selected hospitals receivers of said selection.

24. The method according to claim 23, wherein said medical facility and physician information includes locations of a physician or hospital and wherein said transfer request template has a populated list of said locations wherein said populated list is ranked by a distance from said originating physician patient originator to said locations.

25. The method according to claim 23, further comprising the step of assigning a unique identification code to each of said one or more receiving hospitals patient receivers identified in said completed transfer request when sending said completed transfer request, wherein said unique identification code is specific to said completed transfer request.

26. (canceled)

27. The method according to claim 23 further comprising the steps of:
providing said online database with a transport request template for wherein said patient originator populates said transport request template to produce a completed transport request;
providing a transporter interface enabling one or more patient transporters to view said completed transport request and to provide a response by completing said response template; and
permitting said originating physician to select a selected transporter selected from said one or more patient transporters.

28. A method to transfer a patient, comprising:
providing an online database comprising medical transporter information, a transport request template and a response template;
permitting a patient originator access to said database to retrieve said transport request template and prepare a completed transport request;
storing said completed transport request within said database;
providing one or more patient transporters notification of said completed transfer request;
permitting said one or more patient transporters access to said database to view said completed transport request;
providing said patient originator notification when each of said one or more patient transporters accesses said completed transport request;
permitting said one or more patient transporters access to said database to retrieve said response template and prepare a completed response to said completed transport request;
providing said patient originator notification of said completed response, wherein the patient originator selects one of said patient transporters to become a selected transporter for awarding said transport and selecting all remaining said one or more patient transporters to become non-selected transporters;
sending a selection notification to said selected transporter notifying said selected transporter of said selection; and
sending a non-selection notification to said non-selected transporters notifying said non-selected transporters of said selection.

29. The method according to claim 28, further comprising the step of assigning a unique identification code to each of said one or more patient transporters identified in said completed transport request when sending said completed transport request, wherein said unique identification code is specific to said completed transport request.

30. (canceled)

31. The system of claim 3 wherein said unique communication code for each of said responding patient receivers not selected by said patient originator is deactivated upon transmittal of said selection communication.

32. The system of claim 1 wherein confidential patient information is transmitted to said selected patient receiver only after transmittal of said selection communication.

33. The system of claim 14 wherein said unique communication code for each of said responding patient transporters not selected by said patient originator is deactivated upon transmittal of said selection communication.

34. The system of claim 13 wherein confidential patient information is transmitted to said selected patient transporter only after transmittal of said selection communication.

35. The method of claim 25 further comprising the step of deactivating said unique communication code for each of said responding patient receivers not selected by said patient originator upon transmittal of said selection communication.

36. The method of claim 23 further comprising the step of transmitting confidential patient information to said selected patient receiver only after transmittal of said selection communication.

37. The method of claim 29 further comprising the step of deactivating said unique communication code for each of said responding patient transporters not selected by said patient originator upon transmittal of said selection communication.

38. The method of claim 28 further comprising the step of transmitting confidential patient information to said selected patient transporter only after transmittal of said selection communication.

39. The method of claim 23 further comprising the step of providing a tracking module and tracking processor wherein each notification is time-stamped for tracking of said transfer request.

40. The method of claim 28 further comprising the step of providing a tracking module and tracking processor wherein each notification is time-stamped for tracking of said transport request.
